(19) United States
(12) Patent Application Publication
(10) Pub. No.: US 2010/0096019 A1
(43) Pub. Date: Apr. 22, 2010

(54) VARIABLE FLOW RESHAPABLE FLOW RESTRICTOR APPARATUS AND RELATED METHODS

(76) Inventor: Paul Mario DiPerna, San Clemente, CA (US)

Correspondence Address: Luce, Forward, Hamilton & Scripps LLP, 2050 Main Street, Suite 600, Irvine, CA, 92614, US

(21) Appl. No.: 12/646,881

(22) Filed: Dec. 23, 2009

Related U.S. Application Data
(62) Division of application No. 11/462,962, filed on Aug. 7, 2006.

(51) Int. Cl. G05D 7/01; F17D 1/16

(52) U.S. Cl. 137/13; 138/45; 137/486; 138/46; 604/500; 604/67

(57) ABSTRACT

A novel apparatus and associated methods for controlling the flow through a flow restrictor using a reshapable lumen. The lumen reshapes as a function of the pressure differential over the flow restrictor. Because flow rate is proportional by the fourth order of magnitude to the diameter of the lumen, small changes in the pressure differential allow for larger changes in the flow rate over conventional flow restrictor systems and provides for real time, fine-tuned adjustments to the flow rate.

### RELATED APPLICATIONS

This application is a divisional application of, claims the priority of, and incorporates by reference U.S. patent application Ser. No. 11/462,962, filed on Aug. 7, 2006.

### BACKGROUND

This invention relates to an apparatus and associated methods for dispensing fluids or gasses at known, measurable rates. More specifically, the present invention relates to flow restrictors having reshapable lumina. The lumina reshapes as a function of pressure, which results in an increase in the flow rate by about a fourth order of magnitude.

### SUMMARY

Disclosed is a novel apparatus and associated methods for controlling the flow through a flow restrictor using a reshapable lumen. The lumen reshapes as a function of the pressure differential over the flow restrictor. Because flow rate is proportional by the fourth order of magnitude to the diameter of the lumen, small changes in the pressure differential allow for larger changes in the flow rate over conventional flow restrictor systems and provides for real time, fine-tuned adjustments to the flow rate.

Likewise disclosed herein is a flow restrictor comprising at least one reshapable lumen, wherein each lumen reshapes as a function of pressure within the lumen.

Similarly, a method of varying the flow rate through a flow restrictor is disclosed, comprising the steps of providing a flow restrictor having at least one reshapable lumen, wherein the lumen reshapes as a function of the pressure within the lumen; and allowing for the pressure of a flow material to increase within each lumen, the increase in pressure causing each lumen to reshape resulting in increased flow rate of the flow material.

Still further disclosed is a method of varying flow rate through a flow restrictor comprising the step of providing a flow restrictor having a reshapable lumen, wherein the flow rate varies as a combination of the diameter of the lumen and the pressure within the lumen by at least about a fourth order of magnitude.

Finally, a method of varying a flow rate of a flow material through a flow restrictor by providing a reshapable lumen, wherein the flow rate of the flow material varies as a) a function of pressure within the reshapable lumen and b) the diameter of the reshapable lumen is also taught according to the present disclosure.

### DRAWINGS

The above-mentioned features and objects of the present disclosure will become more apparent with reference to the following description taken in conjunction with the accompanying drawings wherein like reference numerals denote like elements and in which:

FIG. 1 is an illustration of an embodiment of a flow restrictor system of the present disclosure;

FIG. 2 is a graph demonstrating the improved utility of the system taught in the present disclosure;

FIGS. 3A and 3B are illustrations of an embodiment of flow restrictors of the present disclosure with a circular lumina in both a resting state and a reshaped state;

FIGS. 4A and 4B are illustrations of an embodiment of flow restrictors of the present disclosure with a non-circular lumina in both a resting state and a reshaped state;

FIGS. 5A and 5B are illustrations of an embodiment of flow restrictors of the present disclosure with multiple lumina in both a resting state and a reshaped state;

FIGS. 6A and 6B are illustrations of an embodiment of flow restrictors of the present disclosure with a reshapable lumen;

FIG. 7 is an illustration of an embodiment of a flow restrictor of the present disclosure with a set of mechanical plates that reshape as the pressure of a flow material increases; and

FIG. 8 is an illustration of an embodiment of a flow restrictor of the present disclosure using a mechanical feedback mechanism to increase the cross-sectional area of a lumen as the pressure of a flow material increases.

### DETAILED DESCRIPTION

In the following detailed description of embodiments of the present disclosure, reference is made to the accompanying drawings in which like references indicate similar elements, and in which is shown by way of illustration specific embodiments in which the present disclosure may be practiced. These embodiments are described in sufficient detail to enable those skilled in the art to practice the present disclosure, and it is to be understood that other embodiments may be utilized and that logical, mechanical, electrical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction unless expressly indicated as such or notated as “xor.”

This application incorporates by reference U.S. Pat. Nos. 7,341,581; 7,374,556; and 7,008,403.

As used in this disclosure, the term “fluid” shall be defined as a liquid or a gas.

As used in this disclosure, the term “flow material” shall be defined as a fluid used to charge a flow material chamber and be dispensed from the same chamber in a subsequent process.

As used herein, the term “real time” shall be understood to mean the instantaneous moment of an event or condition, or the instantaneous moment of an event or condition plus short period of elapsed time used to make relevant measurements, optional computations, etc., and communicate the measurement, computation, or etc., wherein the state of an event or condition being measured is substantially the same as that of the instantaneous moment irrespective of the elapsed time interval. Used in this context “substantially the same” shall be understood to mean that the data for the event or condition remains useful for the purpose for which it is being gathered after the elapsed time period.

For the purposes of the present disclosure, the term “reshape” or “reshapeable” as applied to a flow restrictor lumen shall be defined to include an increase or decrease in the cross-sectional area of the lumen while retaining the same or a different overall shape.

The term “diameter” as used in the present disclosure shall mean the length of a straight line drawn from side to side through the center of the object for which the diameter is being measured.

The present inventors have discovered that by using pressure to vary not only the pressure differential, but also the diameter of the flow restrictor lumen, large changes in flow rate may be effected by small changes in pressure. Moreover, by varying the shape of the lumen, further fine tuning of the flow rate could be effected.

Flow restrictors are common in many applications where regulation of the rate of flow is important. Flow restrictors allow for delivery of a gas or fluid at a controlled rate and may be predetermined or variable. Generally, the rate of flow may be calculated by the equation:

$$FlowRate ∼ \frac{Δ P μ {d}^{4}}{L}$$

where ΔP is the pressure differential at the ends of the flow restrictor, μ is the viscosity of the flow material, d is the diameter of the flow restrictor lumen, and L is the length of the flow restrictor. The flow material may be gas, fluid, or combinations of the same, as is known to artisans.

When flow material flows through flow restrictor, the rate of flow is proportional to the viscosity of the fluid. As fluid viscosity increases, flow rate increases. In most systems, however, viscosity of the flow material is constant. Likewise, the length of the flow restrictor is constant. Length is measured from one end of the lumen to the other end.

Prior to the teachings of the present disclosure, fixed diameter flow restrictors were used to provide a constant, pre-determined flow of flow material. A general problem associated with these flow restrictors was how to control the rate for flow through the restrictor. Prior to this disclosure, flow was controlled by controlling the pressure on either side of the flow restrictor. By increasing pressure in input reservoir, the rate of flow would increase because of the linear relationship between flow rate and pressure differential. Likewise, decreasing the pressure at the exit end of the flow restrictor tended to increase the pressure differential resulting in an increased flow rate.

In other conventional systems, users desired a variable flow rate. Naturally, the 1:1 proportionality of the pressure differential to the flow rate proved to be an effective means of variably controlling the rate of flow. Nevertheless, practical limitations prevented large changes in the flow rate. For example, if the desired flow rate was 50 times the original flow rate, the pressure would have to be increased 50 times, which necessitated building systems that could withstand large pressure swings. These types of systems were generally impractical in many circumstances due to cost, size, and material limitations, among other reasons. Instead, conventional systems typically used methods of slowing down flow rate to decrease the flow.

The present disclosure improves upon and addresses many of these issues by varying the diameter, measured a function of cross-sectional area of a flow restrictor lumen, in addition to pressure. Coupled with the use of a pump that can provide feedback on the volume of flow material delivered, the flow restrictor of the present disclosure provides a tool that can produce fine-tuned steady flow rates, in addition to a large range of flow rates.

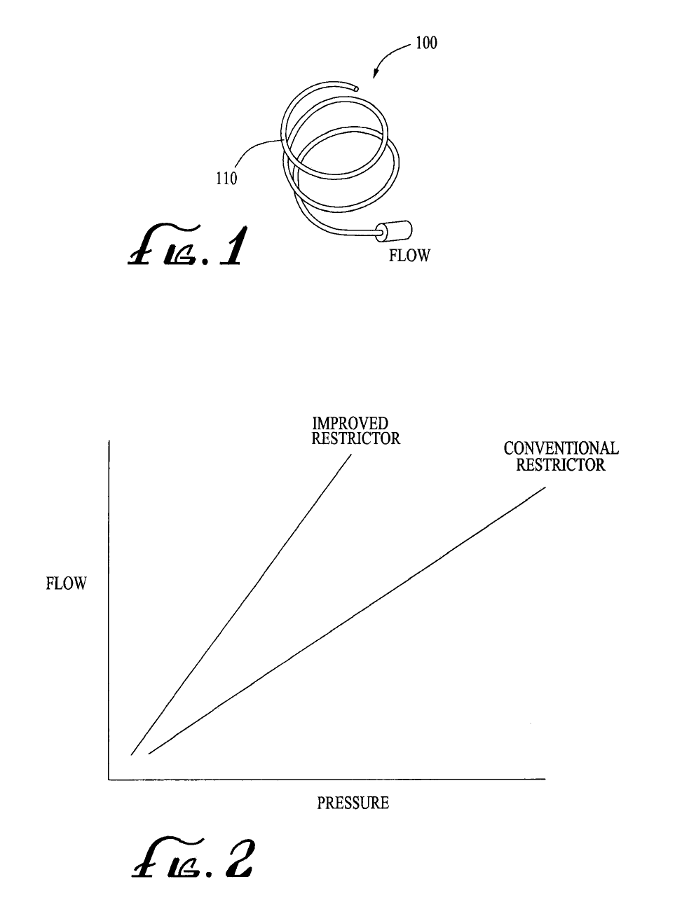

Turning now to an embodiment of the present disclosure demonstrated in FIG. 1, there is generally shown flow restrictor system 100. More specifically, flow restrictor system 100 comprises, in part, flow restrictor 110. Flow restrictor 110 may be any conventional flow restrictor, such as a capillary tube, designed to have flow restrictor lumen 120 vary as a function of pressure. As flow material flows through flow restrictor lumen 120, friction with flow restrictor lumen walls impede the free flow of the flow material, as is well understood by persons of ordinary skill in the art.

In the exemplary embodiment demonstrated in FIG. 1, flow restrictor 110 is made from soft, biocompatible compliant members, for example silicon rubber, natural rubber, polyisoprene, or urethane. Because these types of materials are soft, flow restrictor lumen 110 is reshapable. However, according to an embodiment, a plasticizer may be added to a flow restrictor 110 to soften harder materials to make the flow restrictor lumen more reshapable. Any plasticizer may be used provided the overall biocompatibility of the compliant member is retained. It will be understood and appreciated by a person of ordinary skill in the art, however, the non-biocompatible materials may be used as well.

Referring again to an embodiment demonstrated in FIG. 1, there is shown generally a flow restrictor system 100. Flow restrictor system 100 comprises a length of a flow restrictor 110, such as a length of tubing and connectors that allow flow restrictor system 100 to make suitable connections. Flow restrictor 110 comprises flow restrictor lumen 120. The inside cross-sectional area of flow restrictor lumen 120 may vary greatly depending on the application and is potentially useful in a variety of fields from nano-scale tubes to garden sprinklers and drip systems to oil field pumps, inter alia.

By using a soft material for flow restrictor no or by adding a plasticizer to flow restrictor 110, the cross-sectional area of flow restrictor lumen 120 becomes variable and may be reshapable. Thus, when coupled to a flow feedback mechanism, larger flow rates may be controlled by manipulating small pressure differentials. According to an embodiment, a suitable feedback mechanism is described in U.S. Pat. No. 7,008,403, which is hereby incorporated by reference in its entirety. The combination of using a feedback mechanism in conjunction with the teachings of the present disclosure allows for a much larger flow range than available in conventional flow restrictors.

FIG. 2 shows an embodiment of the utility of the present disclosure over conventional systems for controlling flow rate through flow restrictor 110. The illustrated graph shows flow rate as a function of pressure differential. The flatter the slope, that is, the closer the slope is to zero, the less sensitive flow rate is to changes in the pressure differential. Conversely, the steeper the slope, the more sensitive flow rate is to changes in the pressure differential. Steeper slopes have the advantage of delivering greater ranges of flow material.

As indicated, the present disclosure allows for flow rate to be manipulated over a smaller pressure differential range than in conventional flow restrictors. For example, to increase flow a conventional flow restrictor requires a greater pressure differential because of its flatter slope. Conversely, improved flow restrictor system 100 taught herein causes an increase to the steepness of the slope shown in FIG. 2 (improved connector), allowing for a greater range of flow than in equivalent conventional flow restrictors. Moreover, by employing the use of a feedback mechanism to monitor flow rate, flow rate may be adjusted to achieve a desired flow rate.

Because the flow rate varies by order of magnitude of 4, small adjustments in pressure produce large changes in flow rate. Indeed, the steeper the slope of the flow rate versus pressure, the more pronounced the effect of small adjustments to pressure on the flow rate. Thus, use of a feedback mechanism allows for fine tuning of flow rate through minute adjustments in the pressure differential. Consequently, the present disclosure utilizes the greater range of flow rates without sacrificing the ability to have sensitive flow rate control.

According to an embodiment demonstrated in FIGS. 3A and 3B, flow restrictor 110 comprises both a resting state and a reshaped state, as shown in FIG. 3A and FIG. 3B respectively. Increasing the pressure differential in flow restrictor lumen 120 causes its cross-sectional area to increase from its resting state, shown in FIG. 3A, to its reshaped state, as shown in FIG. 3B, where the cross-sectional area of flow restrictor lumen 120 is increased. The actual degree to which flow restrictor reshapes is a function of the pressure differential.

Similarly, reduction of the pressure differential causes flow restrictor lumen 120 in the reshaped state to return to the resting state shown in FIG. 3A. Indeed, changes to the pressure differential may be effected, which will tend to change the cross-sectional area of flow restrictor lumen 120. Flow rate will therefore be variable not only because flow rate is proportional to the pressure differential, but because the flow rate is proportional to the fourth root of the diameter (measured as a function of cross-sectional area) of flow restrictor lumen 120, the cross-sectional area of flow restrictor lumen 120 being determined by the pressure in flow restrictor lumen 120.

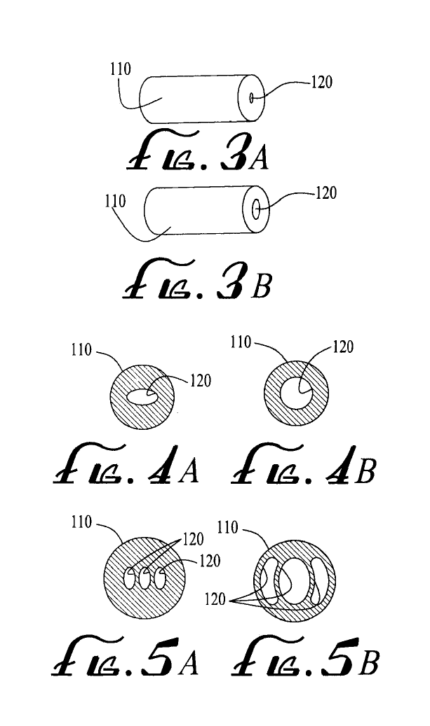

The present disclosure further discloses flow restrictors 110 with customizable improved slopes shown in FIG. 2. FIG. 4A and FIG. 4B each respectively demonstrate an embodiment in a system wherein the slope of flow rate as a function of pressure differential may be further increased, giving additional ranges of flow rates as a function of pressure. By varying the shape of flow restrictor lumen 120, the slope of flow rate versus pressure differential may be fine tuned. In the embodiment disclosed in FIG. 4A, flow restrictor lumen 120 of FIG. 4A is oval, for example. Naturally, the flow rate through an oval lumen in a resting state differs from the flow rate through a circular lumen in the lumen's reshaped state due to the increase in the cross-sectional area in the circular lumen. As the pressure differential increases, flow restrictor lumen 120 reshapes, becoming more circular in the process. Thus, the slope of flow rate as a function of pressure differential is further modified as a result of lumen shape as compared to a circular lumen.

According to known, disclosed, and prototypical embodiments, flow restrictor lumens 120 may combine the effects of reshaping lumen 120 to increase the cross-sectional area of lumen 120 and expansion of the lumen to increase the cross-sectional area of lumen 120 to have more precise control over the flow rate.

Similarly, FIG. 5A and FIG. 5B demonstrate other and further embodiments comprising multiple flow restrictor lumina 120. The embodiment shown in FIG. 5A shows flow restrictor 110 comprising multiple lumina 120 in a resting state. As the pressure differential is increased, flow restrictor lumina 120 reshape. The walls of lumina 120 are thin, which allows each lumen to expand in a reshaped confirmation without causing the outer diameter of the flow restrictor to increase. In reshape configuration, additional flow is effected due to reshaped cross-sectional area of the lumina. Consequently, the slope of the flow rate as a function of pressure differential may be further manipulated as both a function of lumen number and lumen shape.

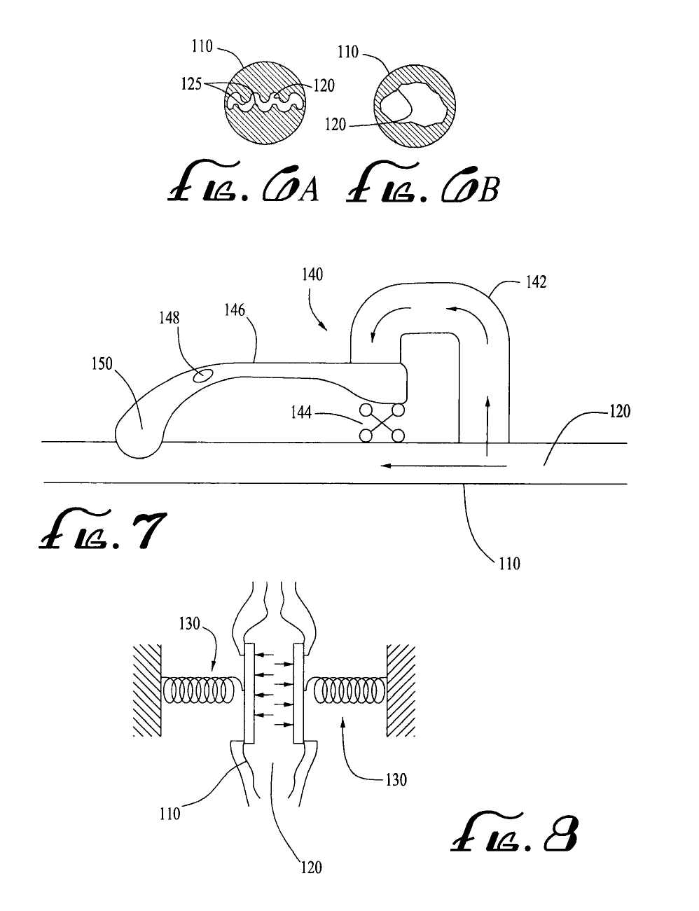

According to an embodiment shown in FIG. 6A and FIG. 6B, there is disclosed flow restrictor 110 comprising a fully reshapable flow restrictor lumen 120. In a resting confirmation, shown in FIG. 6A, flow restrictor lumen 120 comprises numerous lumen extensions 125. As the pressure of a flow material increases, the pressure forces the lumen extensions 125 to reshape into a configuration shown in FIG. 6B, thereby greatly increasing the flow as the cross-sectional area reshapes according to the principles disclosed previously. Lumen extensions 125 may be rugae or other extensions into lumen 120, or in some cases even non-smooth lumen walls.

An additional secondary feature contemplated by the present disclosure allows for further control of flow by increasing resistance to flow internally using lumen extensions 125 into lumen 120, similar to the embodiments shown in FIG. 6A and FIG. 6B. In addition to the benefit imparted by the variation in lumen diameter as previously discussed, lumen extensions 125, such as rugae in FIG. 6A and FIG. 6B, extend into lumen 120 and increase resistance due to increased boundary layer volume, which causes turbulent flow. As a flow material moves through lumen 120 in its unexpanded state, the increased surface area of lumen 120 creates a greater ratio of the flow material that constitutes a boundary layer. In other words, when lumen extensions 125 are introduced the ratio of the surface area to the cross section of the flow material increases, which induces greater turbulent flow within the flow material fluid. As the turbulence within the flow material increases, the internal resistance of the flow material increases, reducing the flow rate.

As the pressure in lumen 120 increases, lumen extensions 125 reshape as shown in FIG. 6B. Once reshaped, the internal resistance decreases, which allows for increased flow rate. The net result of using lumen extensions 125 is a wider range of possible flow rates. A person of ordinary skill in the art will appreciate and understand that the variation in flow rate due to lumen extensions 125 in lumen 120 is only a small component to the variation of flow rates possible contemplated in the present disclosure. The majority of the flow rate variation is due to the change in diameter associated with the increase or decrease of pressure within lumen 120.

Similarly, FIG. 7 is an embodiment that uses a mechanical system to effect an increase in the cross-sectional area of a flow restrictor as a function of pressure. According to the embodiment of FIG. 7, a flow restrictor may be made of non-reshapable materials, such as noncompliant metals and plastics, while providing the same functionality of the flow restrictors described in the present disclosure. Flow restrictor 110 comprises flow restrictor lumen 130 as other flow restrictor systems described previously in this disclosure. Because the flow restrictor of FIG. 7 is non-reshapable, flow restrictor lumen plates 125 are installed into flow restrictor 110 at the point where flow is to be restricted.

Flow restrictor lumen plates 125 connect to flow restrictor springs 130. Flow restrictor springs 130 maintain flow restrictor plates 125 in an unreshaped position. In the unreshaped configuration, flow restrictor plates 125 are in a configuration where the distance between each flow restrictor plate 125 is minimized or, in embodiments, the distance between flow restrictor plate 125 and a wall of lumen 120 is minimized. Consequently, the cross-sectional area of flow restrictor 110 is minimized when flow restrictor plates 125 are in an unreshaped configuration. When the pressure of a flow material increases, flow restrictor plates 125 assume a reshaped configuration. In the reshaped configuration, the pressure of the flow material compresses flow restrictor springs 130 due to the increased pressure exerted on flow restrictor plates 125, expanding the cross-sectional area of flow restrictor lumen 120 to effect greater flow rates as previously described.

Flow restrictor springs 130 are connected to flow restrictor mount 135. Flow restrictor mount 135 remains fixed with respect to flow restrictor system 100, such that when flow restrictor springs 130 compress, flow restrictor mount 135 remains fixed relative to the changed positions of flow restrictor springs 130 and flow restrictor plates 125. Thus, both flow restrictor plates 125 and flow restrictor springs 130 are movable, but flow restrictor mount 135 is fixed with respect to flow restrictor plates 125 and flow restrictor springs 130. Thus, flow restrictor springs 130 return flow restrictor plates 125 to an unreshaped configuration when unpressured by a flow material.

According to a related embodiment shown in FIG. 8, there is shown flow restrictor 110 with a mechanical mechanism for increasing the cross-sectional area of flow restrictor 110. According to the exemplary embodiment of FIG. 8, flow restrictor 110 comprises mechanical lever system 140. In addition to flow restrictor lumen 120, secondary flow restrictor lumen 142 branches off from flow restrictor lumen 120. Flow material flowing into secondary flow restrictor lumen 142 from flow restrictor lumen 130 is at substantially the same pressure as flow restrictor material in flow restrictor lumen 120. As shown in FIG. 8, however, secondary flow restrictor lumen 142 abuts with a proximal end of lever 146. Lever 146 prevents further flow of flow material. Nevertheless, the pressure of flow material is exerted on the proximal end of lever 146. Proximal end of lever 146 is positioned between secondary flow restrictor lumen 142 and mechanical lever system spring 144 to take advantage of the pressure exerted by flow material on the proximal end of lever 146.

Mechanical lever system spring 144 exerts force on lever 146 towards secondary flow restrictor lumen 142. Thus, the pressure exerted by a flow material and mechanical lever system spring 144 act opposite of each other, which determines the position of lever 146. Lever 146 pivots on mechanical lever system pivot 148, according to the exemplary embodiment. It will be understood by a person of ordinary skill in the art, however, the mechanical lever system pivot 148 is unnecessary to variations on the embodiment shown in FIG. 8.

The distal end of lever comprises resizer 150. In an embodiment, resizer 150 applies pressure to flow restrictor 110 downstream of the confluence between flow restrictor lumen 120 and secondary flow restrictor lumen 142. Mechanical lever system spring 144 applies pressure to the proximal end of lever 146, causing resizer 150 to apply pressure to flow restrictor 110. The effect of the pressure applied by resizer 150 to flow restrictor 110 reshapes flow restrictor lumen 120 with a smaller cross-sectional area, which reduces the flow rate of flow material. Conversely, pressure from flow material on lever 146 acts in opposition to mechanical lever system spring 144, causing resizer 150 to reduce pressure on flow restrictor 110, which effects a greater cross-sectional area of flow restrictor lumen 120.

Resizer 150 may apply pressure directly to flow restrictor 110 as shown in FIG. 8 or it may be integrated into flow restrictor lumen 120 as a physical impediment to flow. For example, resizer 150 may be integrated through the wall of flow restrictor 120. As pressure from mechanical lever system spring 144 is applied, resizer 150 pushes into flow restrictor lumen 120, causing a physical impediment to flow of flow material and reducing a cross-sectional area of flow restrictor lumen 120. Conversely, increased pressure of flow material counteracts the force of mechanical lever system spring 144, causing resizer 150 to withdraw from flow restrictor lumen 120, increasing the cross-sectional area of flow restrictor lumen 120.

The present disclosure also discloses methods for using flow restrictor system 100. Flow restrictor system 100 is connected to a feedback mechanism as would be understood by a person of ordinary skill in the art. Once connected, a flow material is added to the system containing flow restrictor system 100. As the flow material flows through flow restrictor 110, the pressure differential determines flow rate in the resting state of flow restrictor 110. As the pressure differential increases by increasing the pressure in the fluid prior to its entering flow restrictor 110 or by decreasing pressure on the end of flow restrictor 110, flow restrictor lumen 120 reshapes causing a further increase in flow rate, in addition to the increase in flow rate directly caused by the increased pressure. The ways in which pressure is manipulated on either side of flow restrictor would be well understood by a person of ordinary skill in the art.

By using the connected feedback mechanism, flow may be controlled with precision. As modifications in the pressure are effected, the flow rate varies. Because flow varies with slight changes in pressure differential, the feedback mechanism is used to adjust flow rate to the desired level. Moreover, the closer the slope of the flow rate as a function of pressure differential is to being undefined (i.e., approaching a vertical slope), the more sensitive the flow rate is to slight changes in pressure differential. Thus, providing a feedback mechanism provides a method for controlling flow with steep sloped flow restrictors 110, where small pressure adjustments cause large flow rate changes.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of varying flow rate through a flow restrictor comprising:
providing a flow restrictor having at least one reshapable lumen for varying the flow rate through the at least one reshapable flow restrictor lumen, wherein the flow rate predictably varies as a function of both the diameter of the lumen and the pressure within the lumen; and
providing a flow rate feedback device for measuring the flow rate of the flow material;
wherein as the pressure of a flow material varies within each lumen, the variance in flow material pressure causes each lumen to reshape resulting in increased flow rate when the flow material pressure is increased or decreased flow rate when the flow material pressure is decreased; and
wherein data from the flow rate feedback device is used to determine the pressure of the flow material and diameter of the reshapable lumen, thereby allowing for control the flow rate of the flow material.

2. The method of claim 1, wherein the flow restrictor is made from a compliant biocompatible material.

3. The method of claim 1, wherein a plasticizer is added to an unmodified flow restrictor made from a biocompatible material to produce the flow restrictor.

4. The method of claim 1, wherein adjustments to the flow rate are calculated by using data derived from the feedback mechanism.

5. The method of claim 1, wherein the resultant reshape of each lumen comprises a larger cross-sectional area when the flow material pressure is increased.

6. The method of claim 1, further comprising providing at least one lumen extension.

7. A method of varying a flow rate of a flow material through a flow restrictor comprising:
providing a flow restrictor having at least one reshapable lumen for varying the flow rate through the at least one reshapable flow restrictor lumen, wherein the flow rate of the flow material predictably varies as a) a function of pressure within the reshapable lumen and b) a function of the diameter of the reshapable lumen; and
providing a flow rate feedback device for measuring the flow rate of the flow material;
wherein as the pressure of a flow material varies within each lumen, the variance in flow material pressure causes each lumen to reshape resulting in increased flow rate when the flow material pressure is increased or decreased flow rate when the flow material pressure is decreased; and
wherein data from the flow rate feedback device is used to determine the pressure of the flow material and diameter of the reshapable lumen, thereby allowing for control the flow rate of the flow material.

8. The method of claim 7, wherein the flow restrictor is made from a compliant biocompatible material.

9. The method of claim 7, wherein a plasticizer is added to an unmodified flow restrictor made from a biocompatible material to produce the flow restrictor.

10. The method of claim 7, wherein adjustments to the flow rate are calculated by using data derived from the feedback mechanism.

11. The method of claim 7, wherein the resultant reshape of each lumen comprises a larger cross-sectional area when the flow material pressure is increased.

12. The method of claim 7, further comprising providing at least one lumen extension;
wherein flow rate of the flow material further varies c) due to at least one lumen extension, the lumen extension increasing surface area upon which a boundary layer forms.

13. A device comprising:
a flow material source, wherein the flow material source controllably pressurizes a flow material;
a flow restrictor comprising at least one reshapable lumen configured to carry flow material from the flow material source to a destination, wherein the flow rate predictably varies as a function of both the diameter of the lumen and the pressure within the lumen; and
a flow rate feedback device for measuring the flow rate of the flow material, the flow rate feedback device providing data whereby the pressure of the flow material is controlled;
wherein the cross-sectional area of each lumen reversibly increases in response to increased flow material pressure, whereby increasing the pressure of the flow material results in an increased flow material flow rate.

14. The device of claim 13, wherein the flow restrictor is made from a compliant biocompatible material.

15. The device of claim 13,
wherein a plasticizer is added to an unmodified flow restrictor made from a compliant biocompatible material to produce the flow restrictor.

16. The device of claim 13, wherein the cross-section of the lumen is a non-annular shape.

17. The device of claim 13, wherein the feedback mechanism provides at least flow rate data in about real time.

18. The device of claim 13, wherein the reshapable lumen further comprises a mechanical lumen reshaper, the mechanical lumen reshaper comprising at least one plate, the plate being connected to at least one spring mounted to a substrate fixed relative to the flow restrictor;
wherein as pressure in the lumen increases, the plate exerts additional pressure on the at least one spring to which it is connected, compressing the spring and effecting an increased cross-sectional area of the lumen.

19. The device of claim 13, wherein the reshapable lumen further comprises a mechanical lumen reshaper, the mechanical lumen reshaper comprising at least one spring actuated lumen resizer and an ancillary flow channel;
wherein when a spring in the spring actuated lumen resizer is uncompressed the cross-sectional area of the reshapable lumen is substantially minimized;
wherein the cross-sectional area of the lumen is modulated by compressing the spring with pressurized flow material in the ancillary channel.

20. The device of claim 13, wherein the at least one reshapable lumen comprises at least one lumen extension.
